(19) United States
(12) Patent Application Publication
(10) Pub. No.: US 2024/0257656 A1
(43) Pub. Date: Aug. 1, 2024

(54) BIMANUAL HAPTIC FEEDBACK COMBINED WITH MIXED REALITY FOR INTRAVENOUS NEEDLE INSERTION SIMULATION

(71) Applicants: Kwangtaek Kim, Aurora, OH (US); Robert John Clements, Stow, OH (US); Jeremy Michael Jarzembak, Chagrin Falls, OH (US); John Timothy Dunlosky, Streetsboro, OH (US); Jennifer Rose Biggs, Aurora, OH (US); Ann James, Hartville, OH (US); Jin Woo Kim, Kent, OH (US)

(72) Inventors: Kwangtaek Kim, Aurora, OH (US); Robert John Clements, Stow, OH (US); Jeremy Michael Jarzembak, Chagrin Falls, OH (US); John Timothy Dunlosky, Streetsboro, OH (US); Jennifer Rose Biggs, Aurora, OH (US); Ann James, Hartville, OH (US); Jin Woo Kim, Kent, OH (US)

(21) Appl. No.: 18/427,112

(22) Filed: Jan. 30, 2024

Related U.S. Application Data
(60) Provisional application No. 63/442,218, filed on Jan. 31, 2023.

(51) Int. Cl. G09B 5/02; G06F 3/01; G06F 3/0354; G06T 19/00; G09B 23/28

(52) U.S. Cl. CPC G09B 5/02; G06F 3/014; G06F 3/016; G06F 3/03545; G06T 19/006; G06T 2210/41; G09B 23/285

(57) ABSTRACT

An assembly for training a user for intravenous (IV) catheter insertion includes a mixed reality display adapted to display a virtual patient and a virtual needle, the mixed reality display including a hand tracking module; a first haptic device including a stylus assembly with a needle assembly; a second haptic device adapted to allow the user to stabilize a hand; and a hand motion controller adapted to track the second haptic device in conjunction with the hand tracking module of the mixed reality display. A method includes utilizing a system to simulate inserting the virtual needle into an arm of the virtual patient with a first set of insertion conditions; adjusting the system to a second set of insertion conditions; and utilizing the system to simulate inserting the virtual needle into the arm of the virtual patient with the second set of insertion conditions.

### CROSS-REFERENCE TO RELATED APPLICATIONS

This application claims the benefit of U.S. Provisional Application No. 63/442,218, filed on Jan. 31, 2023, which is incorporated herein by reference.

### STATEMENT REGARDING FEDERALLY SPONSORED RESEARCH OR DEVELOPMENT

This invention was made with government support under grant/contract 2118380 awarded by National Science Foundation. The government has certain rights in the invention.

### FIELD OF THE INVENTION

One or more embodiments of the present invention relate to a haptic-mixed reality intravenous needle insertion simulation assembly. One or more embodiments of the present invention relate to a corresponding system. One or more embodiments of the present invention relate to corresponding methods.

### BACKGROUND OF THE INVENTION

A common hospital procedure is the insertion of an intravenous catheter (IVC). Infusion therapy utilizing intravenous catheters provides a route to administer life sustaining fluids, electrolyte replacement, and pharmacological agents. Intravenous catheters also allow for extracting blood for testing and diagnostic purposes. Unfortunately, not all IVC insertions are successful, especially on the first attempt.

Venipuncture skills are among the most challenging for a novice nurse to master when in training and transitioning into practice. Poor success rates have been attributed to confidence issues, improper angle of insertion, and lack of opportunities.

Educational opportunities to train IVC skills are typically performed on plastic manikin arms, which generally provide insufficient replacement for the realism and variability required to achieve mastery. In addition, teaching this skill requires many consumable products and costly medical devices, e.g., single use intravenous (IV) catheters and the manikin arms.

Therefore, there is a need in the art for improvements for enhancing learning and training for intravenous catheter insertion.

### SUMMARY OF THE INVENTION

A first embodiment provides an assembly for training a user for intravenous (IV) catheter insertion, the assembly including a mixed reality display adapted to display a virtual patient and a virtual needle, the mixed reality display including a hand tracking module; a first haptic device including a stylus assembly with a needle assembly; a second haptic device adapted to allow the user to stabilize a hand; and a hand motion controller adapted to track the second haptic device in conjunction with the hand tracking module of the mixed reality display.

A further embodiment provides a system which includes the assembly coupled with a computer.

An additional embodiment provides a method utilizing the system, the method including providing the system having a first set of insertion conditions; utilizing the system to simulate inserting the virtual needle into an arm of the virtual patient with the first set of insertion conditions; adjusting the system to a second set of insertion conditions; and utilizing the system to simulate inserting the virtual needle into the arm of the virtual patient with the second set of insertion conditions.

### BRIEF DESCRIPTION OF THE DRAWINGS

FIG. 1 is a schematic of a haptic-mixed reality intravenous needle insertion simulation system including a haptic-mixed reality intravenous needle insertion simulation assembly;

FIG. 2 is a photo of a virtual reality environment of the simulation system;

FIG. 3 is a perspective view of a haptic needle assembly of the simulation assembly;

FIG. 4 is a schematic of a calibration method;

FIG. 5 is a schematic of a multilayer mesh-based framework for simulating intravenous needle insertion;

FIG. 6 is a graph showing results comparing skin force profiles of the simulation system compared with a manikin arm;

FIG. 7 is a graph showing results comparing vein force profiles of the simulation system compared with a manikin arm;

FIG. 8 is graphs showing results from user performance with the simulation system;

FIG. 9 is graphs showing additional results from user performance with the simulation system; and

FIG. 10 is photos of a checkerboard box for a calibration method.

### DETAILED DESCRIPTION OF ILLUSTRATIVE EMBODIMENTS

One or more embodiments of the present invention relate to a haptic-mixed reality intravenous (HMR-IV) needle insertion simulation assembly. One or more embodiments of the present invention relate to a corresponding system. One or more embodiments of the present invention relate to corresponding methods. One or more embodiments of the present invention system include a bimanual haptic interface completely integrated into a mixed reality and/or virtual reality system with programmable variabilities considering real clinical environments. Advantageously, embodiments of the present invention disclosed herein offer the ability for enhancing learning and training for intravenous catheter insertion.

Embodiments of the present invention allow users, such as nursing students and healthcare professionals, to practice intravenous (IV) needle insertion into a simulated/virtual arm. The practice will serve to improve the psychomotor skill development necessary for enhancing learning to achieve mastery. Embodiments of the present invention allow for multiple attempts at IV needle insertion under a variety of insertion conditions. The insertion conditions can be varied for skin, such as differences in color, texture, stiffness, and friction. The insertion conditions can be varied for a vein, such as differences in size, shape, location depth, stiffness, and friction. The insertion conditions may be fluctuated in order to provide for sufficient realism and variability, which aids in accounting for the differences in these conditions among human patients.

As further described herein, the IV insertion simulation allows for a variety of different insertion conditions. Moreover, a force-profile-based haptic rendering algorithm provides realistic haptic feedback to the user while inserting the needle into the virtual vein. Also, improved haptic glove tracking is disclosed, which utilizes a hand tracking sensor. Embodiments of the present invention can further include calibrating the haptic and mixed reality system with a calibration box using a camera sensor. And the system and methods were tested to verify the realism.

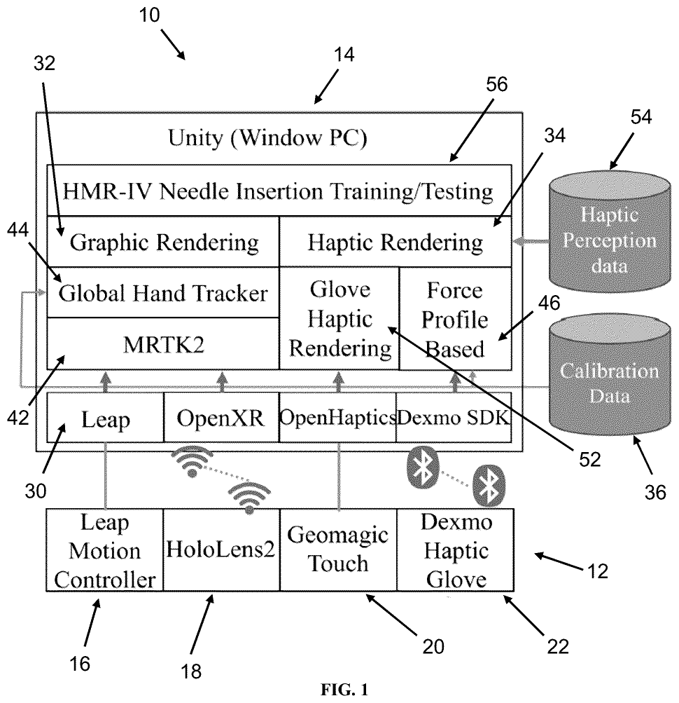

With particular reference to the Figures, FIG. 1 shows a haptic-mixed reality intravenous (HMR-IV) needle insertion simulation system 10. Haptic-mixed reality intravenous needle insertion simulation system 10, which may also be referred to as simulation system 10 or system 10, includes a haptic-mixed reality intravenous (HMR-IV) needle insertion simulation assembly 12 coupled with a computer 14, which can be a desktop computer or a handheld computer. As further discussed herein, the system 10 may include one or more modules of mixed reality (MR) and/or virtual reality (VR) graphic rendering, haptic rendering, and hand tracking.

Haptic-mixed reality intravenous needle insertion simulation assembly 12, which may also be referred to as simulation assembly 12 or assembly 12, includes a hand motion controller 16, a mixed reality display 18, a first haptic device 20, and a second haptic device 22.

The hand motion controller 16 works in conjunction with a hand tracking module of the mixed reality display 18 to achieve accurate global hand tracking. An exemplary hand motion controller 16 is the controller available under the name Leap Motion Controller. Another exemplary hand motion controller 16 is the controller available under the name Vive tracker attached to a haptic glove and tracked by a corresponding base station. As discussed further herein, one or more embodiments of the system include a hybrid global hand tracking system, which can combine the hand motion controller 16 and the hand tracking of the mixed reality display 18, which may also be referred to as combining two depth sensors. The hybrid global hand tracking system can accurately track one or more of the first haptic device and the second haptic device. That is, the hybrid global hand tracking system can accurately track a haptic device (e.g., glove) and can simulate grasping a virtual hand with force feedback.

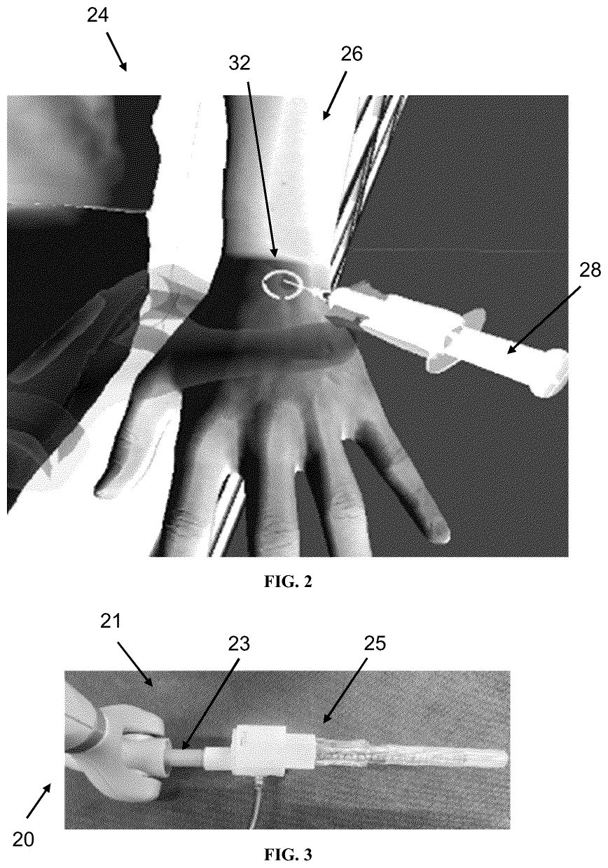

The mixed reality display 18 allows a user to see their real hands in conjunction with a virtual image 24 (FIG. 2). The mixed reality display 18, which may be referred to as mixed reality glasses 18 or virtual reality glasses 18, also allows the user to see virtual graphic images, such as a virtual patient 26 and a virtual needle 28. The image in FIG. 2 shows a graphic of needle insertion simulation using two hands (i.e., the left hand for stabilizing and the right hand for inserting the virtual needle 28). The mixed reality display 18 may also display information to the user, such as insertion angle and state of the needle insertion by text as virtual guidance feedback. An exemplary mixed reality display 18 is the mixed reality head-mounted display available under the name Microsoft HoloLens 2. The mixed reality display 18 may be a standalone mixed reality and/or virtual reality system which is integrated and synchronized through multistep calibration using Direct Linear Transformation and homogenous transformation for different coordinate systems (e.g., real world, virtual world, virtual reality, mixed reality world, haptic interface world, HoloLens camera), as discussed further herein below. The mixed reality display 18 displays images or holograms by a holographic remote system that renders the image from the computer 14 and transfers it to the mixed reality display 18 in real-time via the connection (e.g., WiFi protocol).

The first haptic device 20 should allow for the user to simulate inserting a needle, normally with their dominant hand. An exemplary first haptic device 20 is a stylus haptic device available under the name Geomagic Touch. Other 3DOF or 6DOF desktop haptic devices may be suitable. As discussed further herein, the first haptic device 20, in conjunction with a force profile based haptic rendering, is able to mimic the real, tactile feeling of IV needle insertion. The first haptic device 20 can include, or can be used in conjunction with, a force sensor to achieve the force profile based haptic rendering.

The first haptic device 20, which may be referred to as a modified haptic needle interface 20, can be or can include a stylus 21 adapted to be used by a dominant hand of the user, the stylus acting as a simulated intravenous catheter. The stylus 21, which can be referred to as stylus assembly 21, can include a stylus end 23 which includes a needle assembly 25. The needle assembly 25 may include the sharp needle end being removed for safety purposes. The first haptic device 20 as a stylus assembly 21 may be a desktop haptic stylus assembly. In one or more embodiments, the first haptic device 20 and the force profile based haptic rendering are sufficient for mimicking the real, tactile feeling of IV needle insertion, such that the system 10 can be devoid of a manikin arm. In other embodiments, the system 10 might include a manikin arm or other assembly for physically imitating a human arm, for insertion of a simulated needle therein.

The second haptic device 22 should allow for the user to stabilize their other hand, normally their non-dominant hand. The second haptic device 22 can be a haptic glove. That is, the second haptic device 22 as a haptic glove can be adapted to be worn on a non-dominant hand of the user. Exemplary second haptic devices 22 include haptic gloves available under the names Dexmo and SenseGlove.

The combination of the first haptic device 20 and the second haptic device 22 may be referred to as bimanual haptic simulation. The first haptic device 20 and the second haptic device 22 may be referred to as being nonhomogeneous but complementary haptic devices. To simulate IV needle insertion with realistic variable conditions such as human skin characteristics (e.g., color, textures, roughness), vein characteristics (e.g., shape, size, thickness, location), and different types of IV catheters, the bimanual haptic simulation is integrated with a mixed reality system, as discussed elsewhere herein, for conducting a bimanual IV needle insertion procedure.

The components of assembly 12 are coupled with computer 14. As shown in FIG. 1, in one or more embodiments, the computer 14 can be a personal computer utilizing a Microsoft Windows operating system. The operating system can implement a development platform, which may be referred to as a real-time 3D development platform. An exemplary platform is the real-time 3D development platform available under the name Unity. As further discussed herein, the various components of assembly 12 should be synchronized and/or calibrated with the development platform.

The particular respective connections between the respective components of assembly 12 and the computer 14 can be any suitable connection known to the skilled person. As shown in FIG. 1, in one or more embodiments, the hand motion controller 16 can be a wired connection (e.g., USB), the mixed reality display 18 can be a wireless connection, the first haptic device 20 can be a wired connection (e.g., USB), and the second haptic device 22 can be a wireless connection (e.g., Bluetooth® wireless connection). As mentioned above, the components should be synchronized with the development platform, which can be through open libraries 30, which may also be referred to as a library layer 30 or layer 30. Exemplary libraries 30 are shown in FIG. 1 and include those available under the names Leap, OpenXR, OpenHaptics, and Dexmo SDK. As shown in FIG. 1, the layer 30 then feeds into the graphic rendering, haptic rendering, and hand tracking.

The haptic mixed reality IV simulation system (HMR-IV Sim) 10 shown in FIG. 1 includes two major components or modules, MR graphic rendering module 32 and haptic rendering 34. For the graphic component of the mixed reality, a graphic scene 24 (FIG. 2) composed of a human patient 26, a vein 32, and the IV needle 28 can be created as a 3D mesh model. The 3D mesh model can be rendered in the development platform (e.g., Unity) using the built-in render pipeline. This can provide an efficient low-quality forward rendering with a single pass that implements only the brightest directional light per pixel for each object when there are multiple light sources.

The built-in shader, which can be a physically based shader, can be applied to increase the realism of interactions in the graphic rendering by adjusting one or more of the following parameters: metallic: 0; smoothness: 0.5; normal map scale: 1; specular highlights and reflection enabled. In addition, graphic rendering parameters simulating variable conditions (e.g., colors and textures of the skin and veins; vein size, shape, and location; IV needle size and blood drawing) can be developed and set to allow for flexibility in programing for practice with various conditions.

These parameters should be synchronized with the haptic rendering to achieve a realistic simulated environment that considers both the visual and haptic perceptions expected in real-world scenarios. For example, to control the variability of vein size and location, the graphic rendering interface can be programmed to be selected at from 10 mm to 7 mm for the vein diameter and from 5.5 mm to 7 mm for vein location (under the skin surface).

For haptic rendering, a suitable algorithm can be utilized for the haptic devices 20, 22 in terms of basic colliders and force feedback. To create a feeling of realistic needle insertion, a force-profile-based needle insertion algorithm can be developed, as further described herein. In the algorithm, variable conditions were implemented. However, rather than graphic variables, a focus can be on stiffness for the vein and skin due to the importance to creating a haptic feeling that mimics real-world experience. These stiffness parameters can be implemented to be adjustable, allowing for two distinguishable values for skin and vein based on a discrimination threshold estimated to measure a human differential threshold for haptic stiffness discrimination in the presence of MR graphic objects. A hand motion controller 16 can be employed to achieve accurate global hand tracking in combination with the hand tracker of the mixed reality display 18. In one or more embodiments, the hand motion controller 16 can be mounted to a center (e.g., right above a camera) of the mixed reality display 18.

Calibration of the mixed reality display 18, which can display both virtual and real objects, can be performed to spatially synchronize the virtual needle 28 with the real needle assembly 25 attached to the haptic stylus device 20, 21 in motion. Without calibration, there can be discrepancies in position and direction between the virtual needle 28 and real needle assembly 25, leading to misperceptions of the needle insertion task in the mixed reality system. Accuracy of the calibration should be considered, since simulated IV needle insertion requires hand-eye coordination as well as fine hand/finger motor skill in terms of locating and inserting the thin virtual needle 28.

The coordinate system of the mixed reality display 18, which may be referred to as a head-mounted display (HMD) 18, can be a right-handed coordinate system that enables the ability to track the HMD position in the real world. Once the user can define a stage that represents the room in the real world, the stage defines a stage origin, which is a spatial coordinate system centered at the user's position and orientation. The HMD position can be tracked based on the stage origin. For this reason, a consistent world coordinate system should be used for calibration within the virtual world, and haptic coordinates should be used to simulate the needle insertion with an overlayed syringe on the haptic stylus.

The calibration method relies on the initial positions of the camera of the mixed reality display 18 and the haptic stylus device 21, 25, which are both measured in the real-world coordinate system. To fix the initial positions of the mixed reality display 18 and the haptic stylus device 21, 25, a device-positioning board (not shown) can be utilized. The device-positioning board, which can be an acrylic panel (e.g., width: 41 cm; height: 26.5 cm; depth: 26.5 cm) with positioning guides for the mixed reality display 18 and the haptic stylus device 21, 25 to be positioned at predefined positions when the system 10 starts. In this way, the synchronization of different coordinate systems can be well maintained, even when the mixed reality display 18 is dynamically in use by the user.

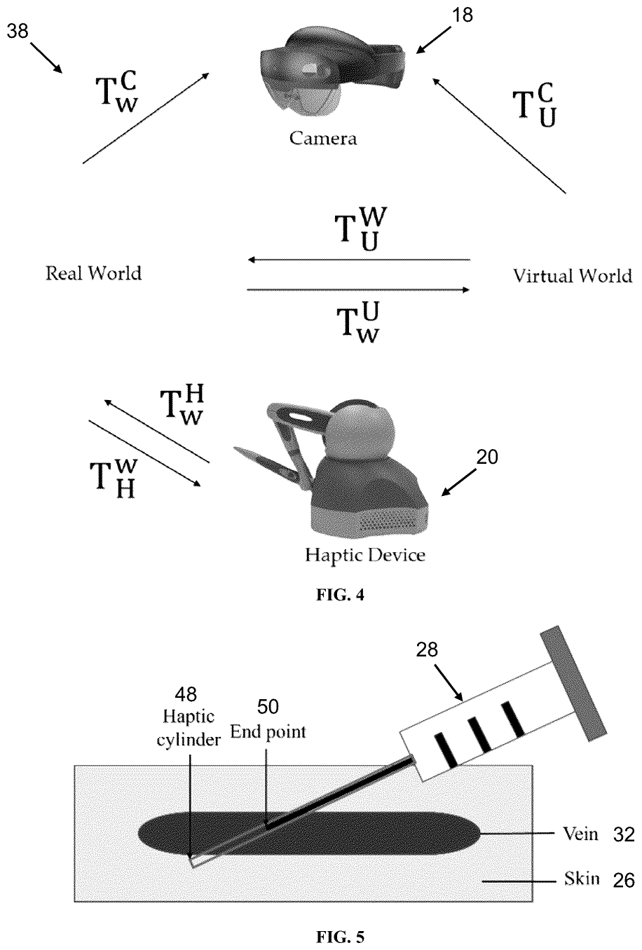

Calibration data computed through this process can be pre-stored in a step 36 and automatically loaded when the HMR-IV Sim system 10 starts, as shown in FIG. 1. Implementing the calibration can include two steps. A first step of mixed reality display 18 (i.e., camera thereof) calibration with the haptic stylus 21, 25 and a second step of coordinate system synchronization between the real world (3D) and virtual world (e.g., Unity 3D). By taking these two steps, the real IVC needle in the haptic local coordinate (3D) can be transformed to the real-world coordinate (3D) system through the coordinate system synchronization process and then projected to the mixed reality display 18 by a projection matrix obtained by camera calibration. The relationship between transformation matrices is further shown in FIG. 4 as a method 38.

To estimate an accurate transform operation from the coordinate system of the haptic device 21, 25 to the eye view of the mixed reality display 18, an MR camera calibration method using Direct Linear Transform (DLT) can be combined with coordinate system synchronization. Due to the offset between the mixed reality display 18 camera position and both eye view positions, the holographic object is overlapped onto the real object in the eye view, and the mixed reality display 18 camera view shows the gap between the holograph and the real object. The root mean square error of the gap from all real control points to virtual control points on the projected image can be found. An example is (−24.5, −31.5) pixels, (−20.9, −21.1) pixels, and (−24.1, −28.25) pixels for a captured image from 0, −45, and 45 degrees, respectively.

The DLT-based calibration method requires at least 6 control points as pairs of corresponding points between 3D (x, y, z) and 2D image coordinates (u, v). The control points, which are 3D points in the real-world coordinate system and projected pixel points on the camera image plane, can be obtained by measurements and then used for estimating the unknown parameters (called DLT parameters) of a 3 by 4 homogenous camera matrix P by solving linear equations ([u; v; w]=P*[X; Y; Z; W]). The projection matrix P, including the estimated parameters, maps any 3D points to the camera image plane, which becomes the mixed reality display 18 view.

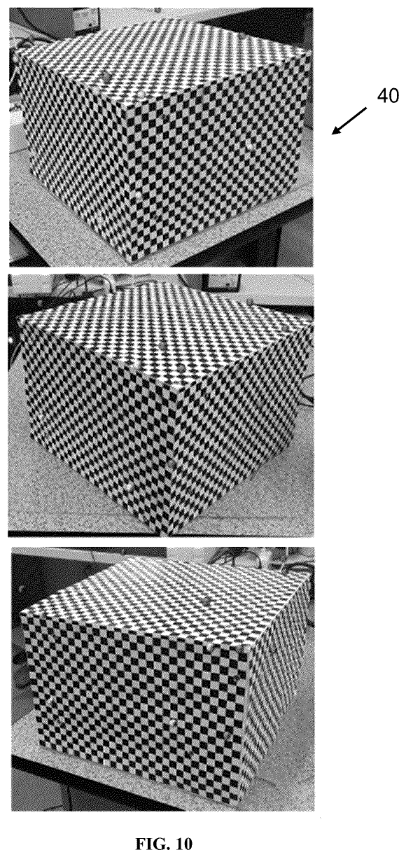

A checkerboard box 40 (FIG. 10) was designed for mixed reality display 18 camera calibration using the DLT method. The calibration box 40 is covered with a checkerboard (e.g., each square side: 1 cm). Each side of the box contains 4 control points at each corner of rectangle to place the point far from other points and cover the calibration space of the box. For calibration, a total of 12 control points at 3 different sides of the box can be selected. The positions of control points in the real-world coordinate system and the corresponding pixel points on the image plane of the mixed reality display 18 camera can be measured using a ruler and an image viewer tool (e.g., Paint program), respectively.

The gyro sensor can be used to maintain the position and orientation of the mixed reality display 18 camera in this step. The origin of the real-world coordinate system is the left front corner of the synchronization board, and for the axis, the right-handed coordinate system can be used. The control points can then be used for computing an initial projection matrix using the DLT method. In this step, 2 points from each side, or a total of 6 points, can be selected to create the matrices and select the matrix with minimum error as the initial matrix. Then, the initial matrix can be iteratively optimized using the Broyden-Flether-Goldfarb-Shanno optimization (BFGS) algorithm, which finds the minimum reprojection errors in the camera image coordinates. As shown in FIG. 4, this calibration process can be repeated for estimating two projection matrices, T_{W}^{C} (the real world to the mixed reality display 18 for the synchronization of the real needle) and T_{U}^{C} (the virtual world (e.g., Unity) to the mixed reality display 18 camera for the synchronization of the virtual needle).

The next step of the calibration process can be computing the homogeneous transformation matrices between 3D coordinate systems, namely the real world, the virtual world, and the haptic stylus system, as each has a different coordinate system. For the coordinate synchronization, four (4×4) transformation matrices (T_{W}^{H}, T_{H}^{W}, T_{U}^{W}, T_{W}^{U}) can be computed using 12 corresponding points between paired coordinate systems (e.g., the real world to the virtual world, the virtual world to the haptic stylus, the real world to the haptic stylus), and then matrices can be optimized with the BFGS. The cost function of the BFGS is the root mean square error of all 12 points generated by 12 4×4 homogeneous matrix parameters.

The mixed reality display 18 may include a hand-tracking algorithm 42, which may be referred to as a hand-tracking module 42, for hand-gesture-based interactions through a mixed reality toolkit (MRTK) (shown as “MRTK2” in FIG. 1). However, a provided hand tracker of a mixed reality display 18 is generally intended to be used for bare hands and may not be suitable to track a hand wearing a haptic glove due to the occlusion of the fingers and hand by the mechanical parts. In the same way, most ungrounded haptic gloves may not be capable of tracking the hands or fingers of the user globally in the world coordinate system, but instead provide local finger tracking referencing the center of the palm of the glove. To resolve this issue, a hand motion controller 16 can be employed with the mixed reality display 18 to achieve a more accurate global hand tracking module 44. That is, the hand tracking module 44 can include tracking of the haptic glove 22 in combination with the hand tracker of the mixed reality display 18.

A hand-tracking algorithm can be utilized that automatically selects either sensor to accurately obtain tracking in a dynamic mixed reality scene. The algorithm can place a higher priority on the hand motion controller 16 because it may demonstrate better performance tracking of the haptic glove (e.g., facing down) while in motion. For one suitable tracking algorithm, synchronization of the two coordinate systems can be done first so that hand-tracking data from the two different sensors can be aligned in a single coordinate system. To achieve this, the same method of coordinate system synchronization described above can be applied, using 12 control points sampled from both coordinate systems for estimating a 4 by 4 transformation matrix that maps the hand motion controller 16 sensor coordinates to the mixed reality display 18 coordinates with a minimum error (e.g., RMSE: 8.6 mm).

The hand-tracking performance may also be affected by illumination and camera viewing angles to be determined by the location of a depth sensor. The location of the hand motion controller 16 sensor may therefore be considered. The location of the hand motion controller 16 can be on the center of the mixed reality display 18 (i.e., while on the head).

The success rate of the grasping gesture tracking should be sufficient to achieve realistic haptic grasping feedback. This may include configuring the tracking such that any tracking failure frames in the grasping gesture are found in the middle of the motion (i.e., not near the end, where haptic force feedback is computed). This may also include configuring the system to activate the local finger tracking of the haptic glove to compute accurate force feedback once the user's hand has been successfully located at the desired grasping position. In this way, the global hand tracking of the haptic glove can be improved. The global hand-tracking module 44 can be designed to select either hand tracker 16, 18 based on the tracking status (i.e., failure or success) of each. The virtual hand position (i.e., palm center) of the haptic glove can be updated with the tracking information of the selected tracker. If both of the trackers would happen to fail to track the haptic glove 22, the algorithm can hold the virtual hand at the last updated position.

In one or more embodiments, two haptic rendering schemes can be developed to simulate realistic IVC needle insertion using the modified 3 DOF (degrees of freedom) haptic stylus 20 and grasping a virtual hand or arm using the exoskeleton glove 22, which can be an 11 DOF glove.

For the IVC needle insertion haptic rendering, a force-profile-based haptic rendering algorithm 46 can be created. The force-profile-based haptic rendering algorithm 46, which may also be referred to as module 46, can include two parts. First, a multilayer mesh-based force rendering framework can be created and optimized for simulating IVC needle insertion with adjustable parameters (e.g., stiffness and friction). Second, the optimum values of the adjustable parameters can be determined using force-profile-based data analysis and user feedback.

The multilayer mesh-based framework can use multiple 3D mesh objects (e.g., skin, vein, needle) at different layers to create different haptic feelings at the skin layer 26 and vein layer 32, respectively, as graphically illustrated in FIG. 5. Each mesh object can be designed to have its own customized mesh collider that detects the collision of the virtual needle 28 accurately. In addition, for the inserted needle 28 to stay at one spot on the skin surface, a cylinder-shaped mesh object 48 can be added to the virtual needle 28. The haptic cylinder 48 haptically guides a penetration path determined by the initial insertion angle on the skin 26 and mimics a realistic insertion feeling created by the inner layer of the skin 26.

The resisting force of the haptic cylinder object 48 is computed only when an end point 50 of the virtual needle 28 is moved into the skin surface 26, which is detected by the position sensor of the first haptic device 20. The resisting force can be optimized by stiffness and friction. Once the haptic cylinder 48 is activated, the needle 28 is not able to break the collider of the cylinder 48 until the end of insertion. Insertion feedback forces can be computed using a virtual proxy model implemented in an open library (i.e., layer 30) (e.g., OpenHaptics library) which can include adjustments to provide haptic rendering parameters (e.g., stiffness, friction, pop-through).

A second step can be determining the optimum values of haptic parameters when inserting into the skin 26 or vein 32. To objectively complete this process, force-profiling-based data analysis can be conducted. A user force profile can be used as the reference point to be similarly formed by the multilayer mesh-based force rendering. This can include estimating the optimum value of stiffness that causes a realistic haptic feeling for the skin 26 and vein 32. Force profiling can be conducted using a high-precision force sensor attached to a real IVC needle during insertion into a manikin arm.

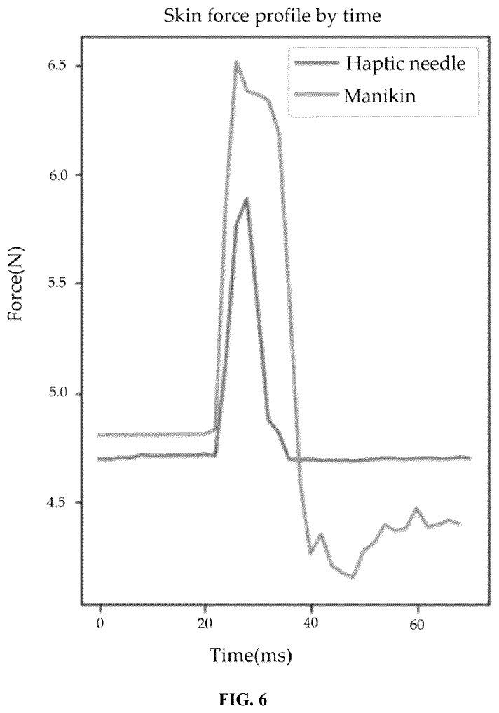

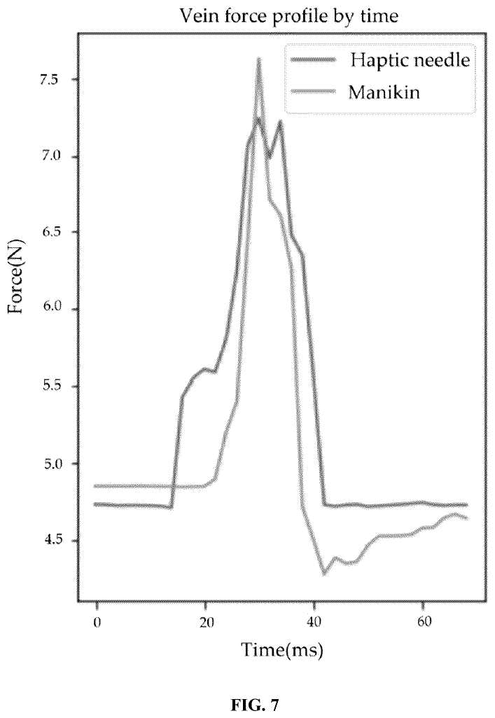

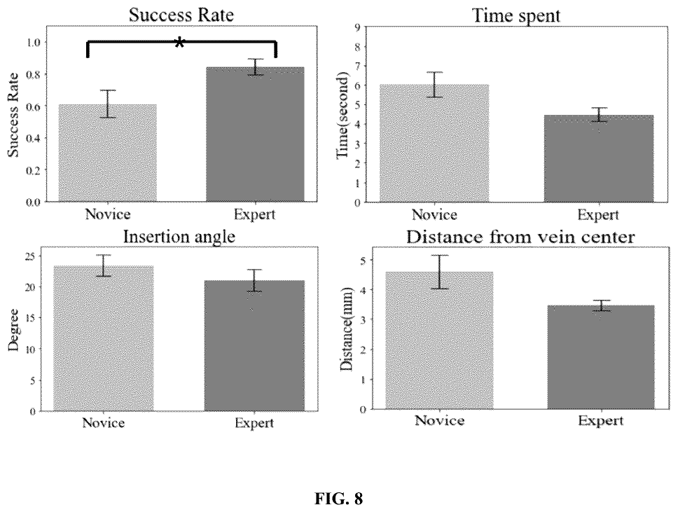

Two force profiles were recorded for the skin and vein (FIG. 6 and FIG. 7). The peaks and shapes of the two profiles are different, where the larger and sharper force peak formed in the vein. To find the best value of stiffness, the same force profiling can be conducted using the same force sensor attached to the modified haptic stylus 20 of the system 10. This force profiling can be repeated while changing the value of stiffness until sufficient force samples are collected to be iteratively compared with the two-reference profile. All the profiles can be recorded (e.g., for 0.2 seC) and then synchronized and compared using the Pearson correlation method. FIG. 6 and FIG. 7 show the comparisons. Best correlation values can be found (e.g., similarity: 0.9511 and 0.8762 for the vein and skin, respectively), which may determine 0.5 and 0.8 as the best values of stiffness for the vein and skin, respectively. Other minor parameters can also be optimized based on user feedback. Exemplary final optimum values of haptic parameters used for the haptic needle simulation can be: Skin: stiffness 0.8, damping 0.9, static friction 0.2, dynamic friction 0.2, pop-through 0.02; and Vein: stiffness 0.5, damping 0.9, static friction 0.2, dynamic friction 0.3, pop-through 0.057.

A haptic glove rendering module 52 can also be implemented using open libraries 30 (e.g., OpenHaptics and Dexmo SDK in Unity) to simulate grasping a virtual hand while a virtual needle is inserted. As mentioned above, global hand tracking can be combined with the haptic finger tracking function. Resisting forces (e.g., max 0.5 N) can be computed when the virtual fingers of the haptic glove touches the virtual hand surface for grasping. This force computing can be implemented using the virtual proxy model.

Rather than visual variables (color, textures, size, shape, etc.), stiffness (hardness) generally determines the haptic variability of the skin and vein. However, a change in stiffness is invisible and completely unknown until the user feels it using a haptic device. Since embodiments include replacing the end part 23 of the haptic stylus 21 with a real IV needle 25, a discrimination threshold of haptic stiffness can be found when using a real needle in the context of fully immersive mixed reality. This may also be referred to as haptic perception data.

Haptic perception data input step 54 (FIG. 1), which may also be referred to as a discrimination threshold 54, can be estimated using the method of limits. The method of limits estimates a perception threshold efficiently and quickly, though with relatively lower accurately, which is still sufficient to determine two distinguishable values of stiffness for system 10. The discrimination threshold can be estimated based on users touching the surfaces of two virtual cubes (e.g., one reference (value: 0.5) and one test stimuli (e.g., a value in the range of 0 to 1)) using the real needle interface 25 attached to the haptic stylus device 21. Ascending and descending series can be presented (e.g., alternately 10 times each) and a step size of stimulus increments, or decrements, can be utilized (e.g., 0.1). The users can then answer which cube is stronger. An exemplary estimated discrimination threshold is 0.169±0.021. This can lead to determining two distinguishable values of skin stiffness: 0.8 and 0.63; and vein stiffness: 0.5 and 0.33. These values can be applied to the haptic IV needle rendering module 34.

As discussed herein, the simulation can include variability of insertion conditions. The skin conditions can include one or more of color, texture, stiffness, friction, and the presence or absence of tattoos. The vein conditions can include one or more of size, shape, location depth, stiffness, and friction. Other conditions for the skin and vein can include one or more of dark skin, large veins, rolling veins, excess hair, geriatric, can palpate, tattoos, light skin, small vein, thick skin, cannot visualize vein, smooth skin, superficial veins, can visualize veins, cannot palpate, thin skin, and deeper veins.

To simulate vein size and/or depth, a skin deformation script can be created to raise the mesh vertices on the hand where the virtual vein 32 would be. This can cause a bulge over the vein 32, giving it an appearance of protruding from the hand, simulating a more prominent vein. A blue line can be added to the color map and the normal map over the vein area to further simulate vein protrusion. The albedo value of the model material can be adjusted to change the skin color. Exemplary skin colors which can be variable include white, tan, and black. Another factor can be the presence or absence of tattoos. This can include variables of three levels of difficulty for the tattoos: no tattoo (easy), pattern tattoo (medium), and anchor tattoo (hard). This can include changing the color map to a hand texture with the tattoo overlayed to apply the tattoos. The many variables can be adjusted to combine various overall difficulty levels, which variability of the difficulty level can be useful for mirroring the variability of real world scenarios. In one or more embodiments, this can include manipulating three variables to provide enough variability to create sufficient scenarios.

Though aspects of one or more methods are disclosed elsewhere herein, additional details of one or more methods are disclosed here. As mentioned above, embodiments of the system 10 disclosed herein offer the ability for a step 56/method 56 (FIG. 1) including various training and testing parameters for enhancing learning and training for intravenous catheter insertion.

A method utilizing the system disclosed herein can include a first step of providing the system with a first set of insertion conditions. The user can then utilize the system to simulate inserting a needle into a human arm with the first set of insertion conditions. The system can then be adjusted to a second set of insertion conditions. The user can then further simulate inserting a needle into a human arm with the second set of insertion conditions. These steps can be repeated for still further insertion conditions.

In one or more embodiments, in order to assist with maintaining stable rendering, the system can be devoid of deformable motion.

### EXAMPLES

### Example 1—Mounting Location of Motion Controller

The hand-tracking performance was analyzed based on the location of a depth sensor. An experiment was performed to find the best location of a Leap Motion sensor for two mounting scenarios: on a desk compared to on the head of a user with a HoloLens 2 device. Success rates of tracking a haptic glove were compared with the glove being worn and tested with different hand postures and gestures. The different hand postures and gestures included facing up, facing down, and grasping a virtual hand. The single sensors were analyzed, as well as the combination according to the details disclosed herein. The success rate of hand tracking was computed using the metric, SR=t/n, where SR denotes the success rate of hand tracking, t denotes the frames during which the glove is tracked, and n denotes total frames. The results are shown in the below Table 1. The results suggest the center of the mixed-reality (MR) headset (on the head) was the best location.

TABLE 1

| Haptic | Hand Postures | | Hand Gesture |
|---|---|---|---|
| Glove Worn | (No Motion) | | (Motion) |
| Sensors | Facing up | Facing down | Grasping a |
| | (Palmar surface) | (Dorsal surface) | virtual hand |
| | | | (Mixed surface) |
| HoloLens 2 | 0.9969 | 0.0016 | 0.4781 |
| Leap Motion | 0.0867 | 0.9454 | 0.0587 |
| (on desk) | | | |
| Combined | 0.9969 | 0.9454 | 0.4781 |
| (on desk) | | | |
| HoloLens 2 | 0.9457 | 0.0087 | 0.4939 |
| Leap Motion | 1 | 0.6474 | 0.5215 |
| (on head) | | | |
| Combined | 1 | 0.6474 | 0.6364 |
| (on head) | | | |

### Example 2—Usability Evaluation

An evaluation experiment was conducted to measure the usability of the HMR IV needle simulation system disclosed herein with human subjects from novices to experts for an IVC needle insertion task using two hands. Twenty participants took part in the experiment. Nine of them were experts who had formal training and had performed more than five successful IV insertions with real patients, while eleven were novices who had no formal IV training or insertions.

The HMR-IV insertion simulation system was developed with a 64-bit Windows desktop PC (Intel® core™ i7-9900K CPU from Intel, Santa Clara, CA, USA, 32 G RAM, and a NVIDIA RTX 2070), a Geomagic Touch haptic device (right hand), a Dexmo haptic glove (left hand), and Microsoft HoloLens 2 were used. The participants were given time to sufficiently familiarize themselves with the IVC needle insertion system after learning the usage protocol. For novice participants, a short tutorial about practicing IVC needle insertion (grip, insertion angles, a pop feeling in the vein, etc.) was also provided.

In the main experiment, participants were asked to repeat an IV needle insertion 64 times (trials) with different variabilities. For each trial, variability conditions (vein location, vein size (diameter), haptic skin, and vein stiffness, with 2 distinguishable levels each) were randomized. Participants were also asked to use earplugs to block external noise. For each trial, instruction texts (start, end, actions to take, etc.) were sequentially displayed through the HoloLens display for participants to complete the experiment without assistance. To guide the target touch positions with haptic devices, visual graphic feedback was provided. For the haptic glove, a semitransparent hand image overlaid on the haptic glove turned green from red, and for the IV needle, a target insertion area was highlighted by an oval. For each trial, participants were asked to wait for 5 seconds without motion when they were confident about a successful insertion into the virtual vein. It took on average 35 min for each participant to complete the experiment.

To measure the usability of the IV needle insertion simulation system, both quantitative and qualitative data analyses were conducted. For quantitative data analysis of success rates of needle insertion, the insertion angles (5 to 30 degrees), task completion time (start and end), and distance (the needle tip end to the vein center) were measured by functions developed in the system. A success rate was calculated by a formula: the number of successful insertions divided by total attempts. The requirements of a successful insertion, defined by an expert using evidence-based practices set forth by the Infusion Nurses Society, include (1) an insertion angle between 5 to 30 degrees (ideally 20 degrees) and (2) the needle tip staying inside the vein once inserted. For qualitative data analysis, subjective responses were analyzed to measure the usability of the system.

To verify the real-time computing performance of the developed system, the update rate of the entire system was measured while the haptic system was running at an update rate over 1 Khz, which can be a minimum requirement for real-time haptic rendering. For the update rate measurement, total frames were divided by the elapsed time from needle insertion start on the skin to the end. This was repeated 10 times and then averaged. The result was 56 frames per second (0.018 s per frame), which is sufficiently fast to conduct the bimanual IV needle insertion procedure in real-time. The system calibration described above was conducted to compute the transformation matrices (FIG. 4). For the calibration of the HoloLens 2 camera, a checkerboard box was designed and used for sampling and measuring control points in the real and virtual worlds. To collect control points from 3 different sides, the box was placed tilted diagonally, while the viewing angle was 0 degrees. Calibration errors, determined using reprojected pixel points by the estimated camera projection matrix, were calculated at three different viewing angles (HoloLens 2 viewing direction: −45 degrees (left), 0 degrees (front), 45 degrees (right)) on the horizontal axis to cover possible viewing scenarios during the experiment. In addition, all other errors of the estimated transformation matrices between 3D coordinate systems (real world, virtual world (Unity), and haptic device local coordinates) were also calculated using 3D reprojection points. The overall results were sufficiently accurate to implement well-synchronized hand-eye coordination using the simulation system, even though four different coordinate systems (virtual world (Unity), real world, haptic world, and HoloLens-based mixed reality world) were integrated to achieve mixed-reality-based fine motor skill training. The average calibration error T_{W}^{C} was 3.56 pixels. This error showed the needle registration error in the eye view was less than 1 cm during the needle insertion process. If the headset was more than 5 m from the working space, the error was distinguishable. However, if the needle insertion task proceeded in a small working space, the error did not increase significantly. In the experiment, participants adapted to the system easily before the main experiment.

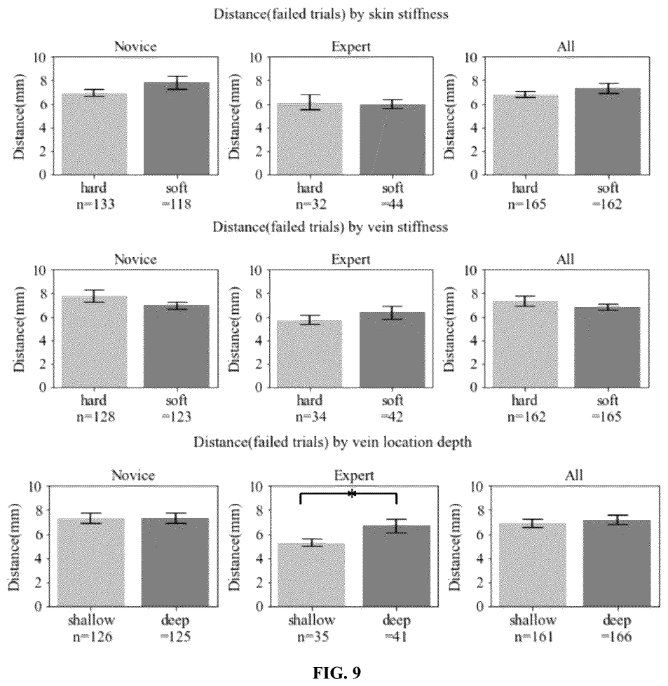

The quantitative results were based on measurements (success rate, completion time, distance from the needle tip to the vein center, insertion angle) automatically recorded in the system during the experiment. The data between two groups (novice and expert) were compared and further analyzed under a statistical analysis using a t-test to see if there was any significant difference between the two groups. FIG. 8 compares the quantitative results between two groups (novice and expert) for all trials regardless of variabilities. The results show that experts succeeded in more trials than novices, which is also confirmed by t-test (Novice: 0.61±0.09%; Expert: 0.84±0.05%; p=0.035). It was determined by t-test analysis that the experts took less time to complete the needle insertion procedure (Novice: 6.02±0.64 s; Expert: 4.47±0.34 s; p=0.029). Regarding the insertion angle, the expert group performed better than the novice group, demonstrating a smaller gap from the desired angle, but no statistically significant difference was detected (Novice: 23.39±1.73 degrees; Expert: 21.03±1.74 degrees, p=0.176). For novices, the needle tip location relative to the center of the vein was noted to be further away compared to the experts, which was statistically different (Novice: 4.6±0.6 mm; Expert: 3.4±0.16 mm; p=0.046). “*” is displayed in the graphs when the p-value from the t-test was lower than 0.05 (* p<0.05).

FIG. 9 shows analysis regarding variabilities (haptic stiffness and vein location depth), which provides an understanding of how the variabilities were well designed to control insertion difficulty levels in the system. The focus was analyzing failed attempts associated with two difficulty levels and the variabilities of haptic distinguishable stiffness (soft and hard for the skin and vein, respectively) and vein location depth (shallow and deep). Distance measurements (needle end tip to the vein center) were also compared to see which group's performance was better, even for failed attempts. In terms of haptic stiffness, results were not consistent between groups. The novice group demonstrated difficulty with the harder surface for insertion into both the skin (133 vs. 118) and vein (128 vs. 123), while the expert group showed the opposite (32 vs. 44; 34 vs. 42). Results of the expert group were consistent for both the skin and vein. Regarding vein location depth, both groups had difficulties with the vein location further from the surface. This difference becomes clearer in the expert group, confirmed by statistical analysis of the distance (Expert: Shallow=5.31±0.26 mm; Deep=6.72±0.58 mm; p=0.041). Table 2 shows the results (success rate, completion time, and distance to the vein center) versus the other variability (vein diameter: big and small). Based on the results of Table 2, the performance was affected by the variability, which was also confirmed by further statistical analyses for both groups.

TABLE 2

| | Novice | Expert | All |
|---|---|---|---|
| Success rate | Big: 0.74 ± 0.08 | Big: 0.93 ± 0.04 | Big: 0.83 ± 0.05 |
| | Small: 0.48 ± 0.1 | Small: 0.75 ± 0.07 | Small: 0.6 ± 0.069 |
| | p-value = 0.057 | p-value = 0.038 | p-value = 0.014 |
| Completion | Big: 5.52 ± 0.2 s | Big: 4.02 ± 0.14 s | Big: 4.84 ± 0.13 s |
| time | Small: 6.54 ± 0.23 s | Small: 4.92 ± 0.15 s | Small: 5.81 ± 0.15 s |
| | p-value = 0.001 | p-value < 0.001 | p-value < 0.001 |
| Distance | Big: 8.62 ± 0.59 mm | Big: 8.76 ± 1 mm | Big: 8.64 ± 0.56 mm |
| from vein: | Small: 5.71 ± 0.28 mm | Small: 5.71 ± 0.28 mm | Small: 6.5 ± 0.26 mm |
| fail trials | p-value = 0.005 | p-value = 0.004 | p-value < 0.001 |

In light of the foregoing, the present invention advances the art by providing improvements for enhancing learning and training for intravenous catheter insertion. While particular embodiments of the invention are disclosed herein, the invention is not limited thereto or thereby inasmuch as variations will be readily appreciated by those of ordinary skill in the art. The scope of the invention shall be appreciated from the claims that follow.

What is claimed is:

1. An assembly for training a user for intravenous (IV) catheter insertion, the assembly comprising
a mixed reality display adapted to display a virtual patient and a virtual needle, the mixed reality display including a hand tracking module;
a first haptic device including a stylus assembly with a needle assembly;
a second haptic device adapted to allow the user to stabilize a hand; and
a hand motion controller adapted to track the second haptic device in conjunction with the hand tracking module of the mixed reality display.

2. The assembly of claim 1, wherein the second haptic device includes a haptic glove.

3. The assembly of claim 2, wherein the haptic glove is adapted to be worn on a non-dominant hand of the user.

4. The assembly of claim 1, wherein the first haptic device includes a desktop haptic stylus assembly, wherein the stylus assembly is adapted to be used by a dominant hand of the user.

5. The assembly of claim 1, wherein the hand motion controller is further adapted to track the first haptic device.

6. A system comprising the assembly of claim 1 coupled with a computer.

7. The system of claim 6, wherein the mixed reality display is coupled with the computer by a first wireless connection, wherein the first haptic device is coupled with the computer by a first wired connection, wherein the second haptic device is coupled with the computer by a second wireless connection, and wherein the hand motion controller is coupled with the computer by a second wired connection.

8. The system of claim 7, wherein the computer employs a real-time 3D development platform, wherein the mixed reality display, the first haptic device, the second haptic device, and the hand motion controller are synchronized with the real-time 3D development platform.

9. The system of claim 8, wherein the first haptic device, the second haptic device, and the hand motion controller are synchronized with the real-time 3D development platform via one or more open libraries.

10. The system of claim 9, wherein the system is adapted to mimic a real, tactile feeling of inserting of an intravenous catheter into an arm.

11. The system of claim 10, wherein the computer is adapted to apply a variety of insertion conditions for the mimicking of the real, tactile feeling of inserting the intravenous catheter.

12. The system of claim 11, wherein the variety of insertion conditions include skin conditions and vein conditions.

13. The system of claim 12, wherein the skin conditions include one or more of color, texture, stiffness, friction, excess hair, thickness, and the presence or absence of a tattoo.

14. The system of claim 13, wherein the skin conditions include adjusting an albedo value for changing the skin color.

15. The system of claim 12, wherein the vein conditions include one or more of size, shape, location depth, stiffness, friction, rolling, palpation, visualization, and protrusion.

16. The system of claim 15, wherein the vein conditions include adjusting a blue line for the protrusion.

17. A method utilizing the system of claim 6, the method comprising
providing the system of claim 6 having a first set of insertion conditions;
utilizing the system to simulate inserting the virtual needle into an arm of the virtual patient with the first set of insertion conditions;
adjusting the system to a second set of insertion conditions; and
utilizing the system to simulate inserting the virtual needle into the arm of the virtual patient with the second set of insertion conditions.
